(19) United States
(12) Patent Application Publication
(10) Pub. No.: US 2025/0200046 A1
(43) Pub. Date: Jun. 19, 2025

(54) VISUALIZATION OF DATA RESPONSIVE TO A DATA REQUEST USING A LARGE LANGUAGE MODEL

(71) Applicant: Capital One Services, LLC, McLean, VA (US)

(72) Inventors: David Thomas SCHULER, Seattle, WA (US); Tanay MEHTA, McLean, VA (US); Omar SANGID, McLean, VA (US); Stephen Eunchul KIM, Los Angeles, CA (US); Joshua Faust WALTON, Centennial, CO (US); Joyce FANG, Falls Church, VA (US); Sudipti GUPTA, Foster City, CA (US)

(21) Appl. No.: 18/540,378

(22) Filed: Dec. 14, 2023

(51) Int. Cl. G06F 16/2455; G06F 40/40

(52) U.S. Cl. CPC G06F 16/24552; G06F 40/40

(57) ABSTRACT

In some implementations, a system may receive the data request. The system may obtain a query associated with retrieving the data responsive to the data request, wherein the query is a first output of a large language model (LLM) that is trained based on metadata associated with a plurality of datasets. The system may retrieve, based on the query, the data responsive to the data request, the data being retrieved from at least one dataset of the plurality of datasets. The system may obtain code associated with providing the visualization of the data responsive to the data request for display, wherein the code is a second output of the LLM. The system may cause, based on the code, the visualization of the data responsive to the data request to be provided for display.

### BACKGROUND

Generative artificial intelligence (AI) is a type of AI technology that describes machine learning systems capable of generating content such as text, images, or code in response to a prompt (e.g., a prompt entered by a user). A generative AI model may use deep learning to analyze common patterns and arrangements in large sets of data and then use information resulting from the analysis to create new outputs. A generative AI model can achieve this, for example, using a machine learning technique such as a neural network. A large language model (LLM) is a type of generative AI that architected to help generate text-based content.

### SUMMARY

Some implementations described herein relate to a system for causing a visualization of data responsive to a data request to be provided for display based on large language model (LLM)-generated code. The system may include one or more memories and one or more processors communicatively coupled to the one or more memories. The one or more processors may be configured to receive the data request via user input associated with a user. The one or more processors may be configured to obtain an LLM-generated query associated with retrieving the data responsive to the data request, the LLM-generated query being generated by an LLM that is configured based on metadata associated with a plurality of datasets. The one or more processors may be configured to execute the LLM-generated query to retrieve the data responsive to the data request. The one or more processors may be configured to obtain LLM-generated code associated with providing the visualization of the data responsive to the data request for display to the user. The one or more processors may be configured to cause the visualization of the data responsive to the data request to be provided for display to the user based on the LLM-generated code.

Some implementations described herein relate to a method for causing a visualization of data responsive to a data request to be provided for display. The method may include receiving, by a system, the data request. The method may include obtaining, by the system, a query associated with retrieving the data responsive to the data request, wherein the query is a first output of an LLM that is trained based on metadata associated with a plurality of datasets. The method may include retrieving, by the system and based on the query, the data responsive to the data request, the data being retrieved from at least one dataset of the plurality of datasets. The method may include obtaining, by the system, code associated with providing the visualization of the data responsive to the data request for display, wherein the code is a second output of the LLM. The method may include causing, by the system and based on the code, the visualization of the data responsive to the data request to be provided for display.

Some implementations described herein relate to a non-transitory computer-readable medium that stores a set of instructions. The set of instructions, when executed by one or more processors of a system, may cause the system to receive a request associated with a plurality of datasets. The set of instructions, when executed by one or more processors of the system, may cause the system to obtain an LLM-generated query associated with retrieving data, from one or more datasets of the plurality of datasets, that is responsive to the request. The set of instructions, when executed by one or more processors of the system, may cause the system to execute the LLM-generated query to retrieve the data. The set of instructions, when executed by one or more processors of the system, may cause the system to obtain LLM-generated code associated with a visualization of the data. The set of instructions, when executed by one or more processors of the system, may cause the system to cause, based on the LLM-generated code, the visualization of the data to be provided for display.

### BRIEF DESCRIPTION OF THE DRAWINGS

FIGS. 1A and 1B are diagrams of an example associated with visualization of data responsive to a data request using a large language model (LLM), in accordance with some embodiments of the present disclosure.

FIGS. 2A and 2B are diagrams of an illustrative example associated with visualization of data responsive to a data request using an LLM, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with visualization of data responsive to a data request using an LLM, in accordance with some embodiments of the present disclosure.

FIG. 5 is a flowchart of an example process associated with visualization of data responsive to a data request using an LLM, in accordance with some embodiments of the present disclosure.

### DETAILED DESCRIPTION

The following detailed description of example implementations refers to the accompanying drawings. The same reference numbers in different drawings may identify the same or similar elements.

Conventional processes for providing a user with a visualization of data are difficult, expensive, and time consuming. For example, in association with providing a visualization of data associated with a subject of interest, a user first needs to refine or preprocess raw data (e.g., stored in one or more databases) to create one or more datasets. The user then needs to correctly identify at least one dataset that includes data relevant to the subject of interest. The user then needs to write and execute a query to obtain the relevant data from the identified dataset(s). After obtaining the relevant data, the user then needs to generate the visualization of the data in a desired manner.

In general, even when data is accessible by a given user, the user may not be equipped to take advantage of tools and the available data in order to generate a visualization, meaning that multiple users or teams of users are needed. Further, a given user or team of users may be unable to reliably identify a dataset(s) relevant to a subject of interest, meaning that multiple queries may need to be written and executed before relevant data is retrieved. As a result, queries against a database may be wasteful and inefficient. Additionally, code associated with one or more of the above operations (e.g., code for a query or code associated with generating a visualization), is typically written manually and therefore is prone to error. This can further reduce efficiency and increase resource wastage (e.g., network resources, processing resources, or the like) associated with data querying and visualization.

Some implementations described herein provide a data processing system that utilizes a large language model (LLM) (e.g., an open source LLM) to enable visualization of data that is responsive to a data request provided by a user. In one implementation, the data processing system receives the data request via user input associated with the user, obtains an LLM-generated query, and executes the LLM-generated query to retrieve data responsive to the data request. The data processing system then obtains LLM-generated code associated with providing a visualization of the data for display to the user, and causes the visualization to be provided for display to the user based on the LLM-generated code (e.g., by providing the LLM-generated code to the user device for execution). In this way, the data processing system, through use of the LLM, improves accessibility to data and enables simple and efficient visualization of the data. In some implementations, the data processing system improves efficiency (e.g., reduced resource consumption with improved accuracy in results) with respect to access and querying of datasets. Further, the data processing system increases efficiency with respect to code generation (e.g., improved accuracy, reducing likelihood of errors, or the like). Notably, the data processing system described herein enables or maintains data security by keeping data internal (i.e., the LLM does not have access to the data itself). For example, the LLM can be trained on metadata about a group of datasets and can generate queries or code, accordingly, without accessing the data itself. Additional details are provided below.

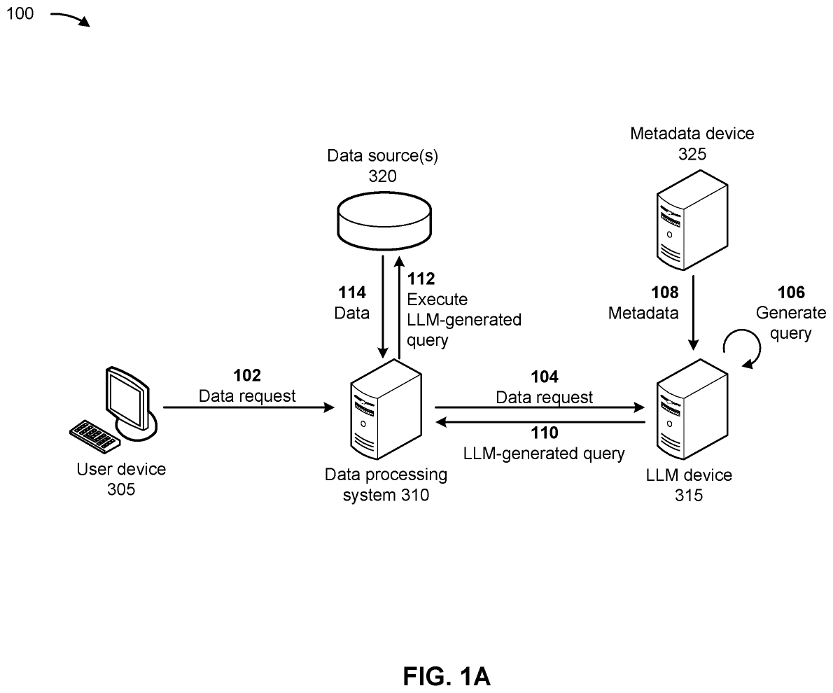

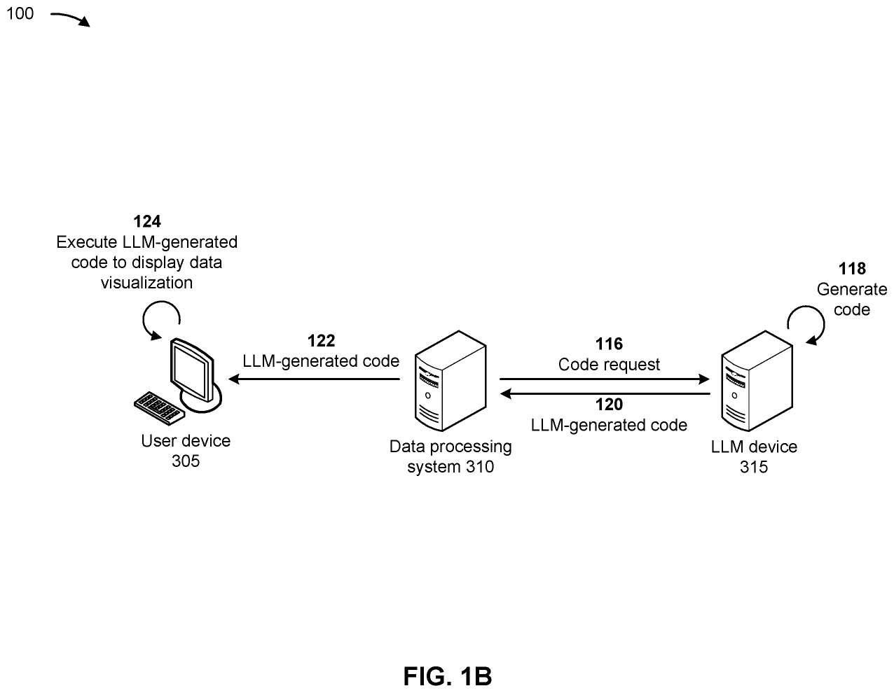

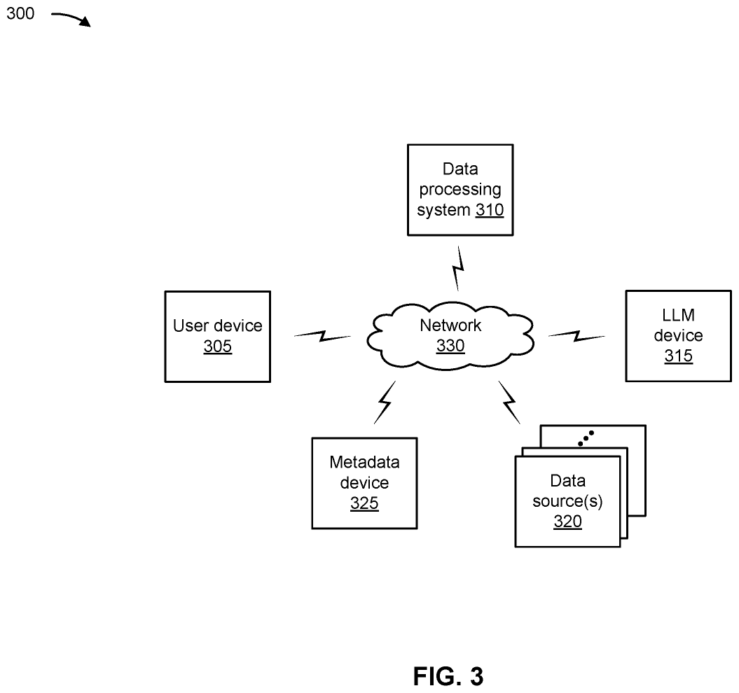

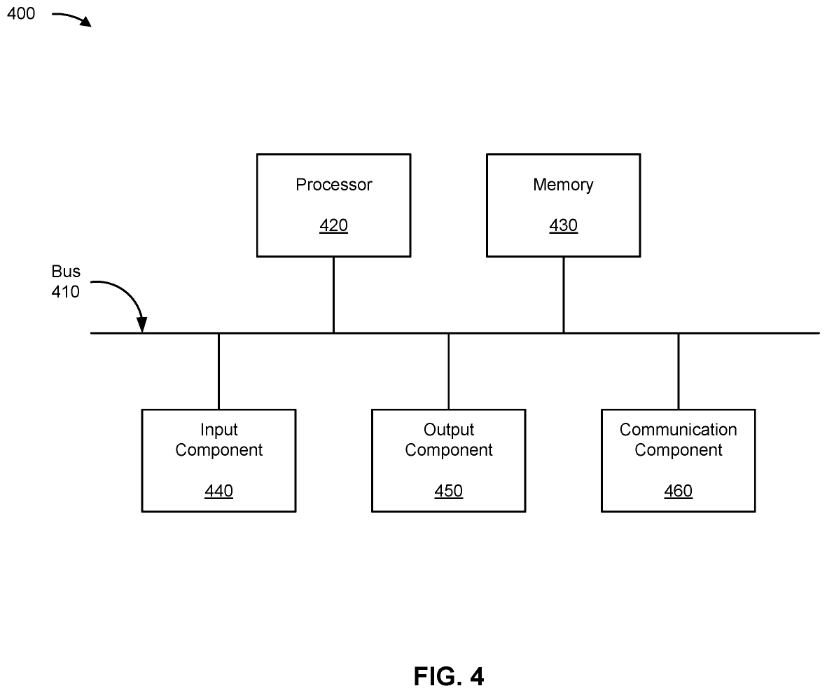

FIGS. 1A and 1B are diagrams of an example 100 associated with visualization of data responsive to a data request using an LLM. As shown in FIGS. 1A and 1B, example 100 includes a user device 305, a data processing system 310, an LLM device 315, one or more data sources 320, and a metadata device 325. These devices are described in more detail in connection with FIGS. 3 and 4.

As shown in FIG. 1A at reference 102, the data processing system 310 may receive a data request. In some implementations, the data request is received via user input associated with a user. For example, the user may provide user input (e.g., via a keyboard, a touchscreen, or the like) to the user device 305, and the user device 305 may provide the data request to the data processing system 310. In some implementations, the data request may be, for example, a string of characters, such as one or more words, a phrase, a question, or the like, that indicates a type of data that the user wishes to retrieve or visualize.

As shown at reference 104, the data processing system 310 may provide the data request to the LLM device 315. For example, the data processing system 310 may receive the data request from the user device 305 and may provide the data request to the LLM device 315. In some implementations, the data processing system 310 may provide, to the LLM device 315 (e.g., along with the data request or in a separate message), a request for an LLM-generated query associated with retrieving data that is responsive to the data request.

As shown at reference 106, the LLM device 315 may generate a query associated with retrieving data responsive to the data request. In some implementations, the query generated by the LLM device 315 includes code that, when executed, enables data relevant to the data request to be retrieved from one or more datasets (e.g., one or more datasets stored on one or more data sources 320). That is, the LLM device 315 may generate a query that, when executed by the data processing system 310, enables the data processing system 310 to retrieve (e.g., from one or more data sources 320) data that is responsive to the data request provided by the user. In some implementations, the query is generated so as to retrieve data from at least one dataset, of a plurality of datasets, that is identified as potentially including data relevant to the data request. Thus, in some implementations, the LLM device 315 may obtain information that identifies at least one dataset to be associated with the query.

In some implementations, at least one dataset that may include data relevant to the data request may be indicated to or identified by the LLM device 315. For example, the LLM device 315 may, in some implementations, be configured based on metadata associated with the plurality of datasets. In such a scenario, as indicated by reference 108, the metadata device 325 may store or have access to metadata associated with a plurality of datasets stored in one or more data sources 320, and may provide the metadata to the LLM device 315. Metadata associated with a given dataset may include one or more items of data that describes or explains data included in the dataset. That is, metadata associated with a given dataset includes data about data included in the data source 320. Notably, the metadata does not include actual data included in the dataset. Thus, the LLM device 315, in some implementations, does not receive or otherwise have access to data in a dataset itself. Rather, the LLM device 315 receives or otherwise has access to metadata associated with the dataset. In this way, security of datasets stored by the one or more data sources 320 is improved or maintained (e.g., by eliminating a chance of a security breach through the LLM device 315). As one particular example, a data source 320 may store a dataset comprising data related to employee card swipes at employer card readers at employer locations. In this example, the metadata may include, for example, a general description associated with the dataset (e.g., “Card swipes at readers”), information that identifies one or more fields included in the dataset (e.g., access type, employee identifier, location identifier, timestamp, or the like), a name of the dataset (e.g., “Card”), or the like. Here, the data may include a value for each field for multiple card swipes. Notably, the metadata does not include the actual data in the dataset (i.e., the metadata does not include actual values carried in the fields of the dataset).

In some implementations, to identify one or more datasets relevant to a data request, the LLM device 315 may include a dataset identification model that is trained based on metadata associated with the plurality of datasets. The dataset identification model may be a model configured to process a data request to identify one or more datasets that include data responsive to the data request. In some implementations, the dataset identification model may be configured or trained using one or more artificial intelligence (AI) techniques. The one or more AI techniques may include, for example, machine learning, a convolutional neural network, deep learning, language processing, or the like. For example, in some implementations, the one or more AI techniques may enable the data processing system 310 to compare data relating to the data request (e.g., one or more keywords, phrases, or the like) to data relating to the plurality of datasets (e.g., metadata associated with the plurality of datasets) to identify one or more datasets that may include data relevant to the data request. That is, in some implementations, the dataset identification model may receive the data request as input and provide information that identifies one or more datasets as an output. Notably, types of data stored by a given data source 320 may vary across the data sources 320. The various types of data stored across the data sources 320 may include, for example, application programming interface (API) data, database data, streaming data, or Big Data. In practice, the dataset identification model may identify datasets that store different types of data. In this way, data across different types of data sources 320 can be joined for utilization by the data processing system 310.

In some implementations, the LLM-generated query may be associated with at least one dataset from one or more datasets identified (e.g., by the LLM device 315) as including data relevant to the data request. For example, the data processing system 310 may provide the data request to the LLM device 315. Here, the LLM device 315 may receive the data request and identify (e.g., using a dataset identification model) one or more datasets, of a plurality of datasets maintained by the one or more data sources 320, that may include data responsive to the data request. In some implementations, the LLM device 315 may identify the one or more datasets based on being trained using metadata associated with the plurality of datasets, as described above. Continuing with this example, the LLM device 315 may, in some implementations, provide information that identifies the one or more datasets identified by the LLM device 315 to the data processing system 310. Here, the data processing system 310 may provide (e.g., to the user device 305) the information that identifies the one or more datasets for display to the user. The user device 305 may display the information that identifies the one or more datasets, accordingly. In some implementations, the data processing system 310 may receive, from the user device 305, user input indicating at least one selected dataset of the one or more datasets identified by the LLM device 315, and the data processing system 310 may forward the user input to the LLM device 315. In such a scenario, the LLM device 315 may generate a query so as to enable data from the selected dataset(s) to be retrieved by execution of the query. Thus, the data processing system 310 may receive input indicating one or more selected datasets that the user wants to use in association with generating a visualization, and an LLM-generated query obtained by the data processing system 310 from the LLM device 315 may be a query associated with the at least one selected dataset of those identified by the LLM device 315.

As an alternative example, the data processing system 310 may select at least one dataset (e.g., without user input). For example, the data processing system 310 may, in some implementations, provide the data request to the LLM device 315, and the LLM device 315 may identify (e.g., using a dataset identification model) one or more datasets as described above. The LLM device 315 may provide information that identifies the one or more identified datasets to the data processing system 310. Here, the data processing system 310 may select at least one dataset. For example, the data processing system 310 may determine that the user is authorized to access a particular dataset of the one or more identified datasets, and that the user is not authorized to access other datasets in the one or more identified datasets. In such a scenario, data processing system 310 may provide, to the LLM device 315, an indication that the LLM-generated query is to be generated for the particular dataset. The LLM device 315 may then generate the query so as to enable data from the particular dataset to be retrieved by execution of the query. Thus, the data processing system 310 may, in some implementations, perform dataset selection automatically (e.g., without user intervention), and an LLM-generated query obtained by the data processing system 310 from the LLM device 315 may be a query associated with the dataset selected by the data processing system 310.

In some implementations, the data processing system 310 may determine whether the user is authorized to access a given dataset that may include data responsive to the data request (e.g., each of the one or more datasets identified by the LLM device 315). That is, the data processing system 310 may, in some implementations, determine whether the user should be permitted access to one or more datasets (e.g., prior to querying a given dataset, prior to obtaining an LLM-generated query, or the like). In one example, if the data processing system 310 determines that the user is not permitted to access a dataset that may include data responsive to the data request, then the data processing system 310 may provide, to the user device 305, a notification indicating the lack of authorization (e.g., so that the user can request access, if desired). In another example, if the data processing system 310 determines that the user is permitted to access a dataset that may include data responsive to the data request, then the data processing system 310 may provide, to the user device 305, a notification indicating that the user authorized. In this way, user authorization can performed by the data processing system 310 even when utilizing the LLM device 315 for identification of datasets and/or generation of a query, meaning that data security is not compromised due to the use of the LLM device 315.

In some implementations, the LLM device 315 may generate the query using a query generation model configured on the LLM device 315. In some implementations, the query generation model may be configured or trained using one or more AI techniques, such as machine learning, a convolutional neural network, deep learning, language processing, or the like. As an example, a given data source 320 may be configured with a respective application programming interface (API) (e.g., a representational state transfer (REST) API) that is documented using a public API specification (e.g., the OpenAPI specification (OAS)). Here, the LLM device 315 may obtain the API specification (e.g., the specification for the API that is that conforms with the OAS) and may train the query generation model based on the API specification. For example, the query generation model may be trained to receive the data request, metadata associated with the plurality of datasets, and/or information that identifies one or more selected datasets as input, and to generate, as an output, code that enables retrieval of data relevant to the data request via the API, with the code being generated according to the API specification.

Notably, while the techniques and apparatuses described herein are described in the context of using a query to retrieve data responsive to a data request, the techniques and apparatuses described herein are applicable to data retrieval in another manner or using another technique. For example, data may in some scenarios need to be retrieved from a data lake that requires a Big Data technology (e.g., Hadoop, Spark, Presto, or the like) to access. While such a technology may in some cases accept a query (e.g., a structured query language (SQL) query), some other cases may request a customized object (e.g., a customized code, a customized function, or the like) for access. In such a case, the LLM device 315 may be configured to generate the customized object or obtain the customized object from a dataset of customized objects that is accessible to the LLM device 315.

As shown at reference 110, the LLM device 315 may provide the LLM-generated query to the data processing system 310. In this way, the data processing system 310 may obtain an LLM-generated query associated with retrieving data responsive to the data request.

As shown at reference 112, the data processing system 310 may execute the LLM-generated query to retrieve data responsive to the data request. For example, the data processing system 310 may execute the LLM-generated query so as to call an API associated with a data source 320 that stores the data responsive to the data request. In some implementations, as shown at reference 114, the data source 320 may provide the data responsive to the data request to the data processing system 310. For example, the data source 320 may, in response to the API call associated with execution of the LLM-generated query, provide a response including the data responsive to the data request. In this way, the data processing system 310 may obtain the data responsive to the data request using an LLM-generated query. In some implementations, the data may be obtained from one or more streaming data sources, meaning that the data is real-time data or near real-time data.

In some implementations, the data processing system 310 may perform post-processing of the data responsive to the data request. For example, the data processing system 310 may in some implementations perform post-retrieval processing when the data comprises “Big Data” such that additional processing is needed to improve utility of the data. Examples of post processing techniques include, for example, converting items of address data to items of latitude longitude data, performing unit conversions for items of data, aggregating items of data, or joining items of data, among other examples.

As shown in FIG. 1B at reference 116, the data processing system 310 may provide a code request to the LLM device 315. In some implementations, the code request is a request for LLM-generated code associated with providing a visualization of the data responsive to the data request for display to the user (e.g., the user of the user device 305). In some implementations, the data processing system 310 may provide the code request along with the data request, along with a request for an LLM-generated query, or in a separate message.

In some implementations, the code request may include information associated with one or more characteristics associated with the visualization. For example, the data processing system 310 may receive (e.g., via user input provided by the user device 305) information that identifies a type of the visualization desired by the user, a property of the visualization desired by the user, or the like. Here, the data processing system 310 may include the information associated with the one or more characteristics in the code request (e.g., such that the LLM device 315 may generate code based on the one or more characteristics).

As shown at reference 118, the LLM device 315 may generate code associated with providing a visualization of the data. In some implementations, the code generated by the LLM device 315 includes code that, when executed, enables a visualization of the data relevant to the data request to be provided for display. That is, the LLM device 315 may generate code that, when executed (e.g., by the user device 305), enables the data retrieved by the data processing system 310 using the LLM-generated query to be provided for display. In some implementations, the code is generated based on information associated with one or more characteristics associated with the visualization (e.g., the code may be generated so that the visualization has one or more characteristics desired by the user as indicated via user input).

In some implementations, the LLM device 315 may generate the code using a code generation model configured on the LLM device 315. In some implementations, the code generation model may be configured or trained using one or more AI techniques, such as machine learning, a convolutional neural network, deep learning, language processing, or the like. As an example, a user interface of the user device 305 may be configured with a particular Javascript library. Here, the LLM device 315 may obtain information that identifies the particular Javascript library and may train the code generation model based on the Javascript library. For example, the code generation model may be trained to receive the code request and information associated with the one or more characteristics of the visualization as input, and to generate, as an output, code that enables a visualization of the relevant to the data request to be displayed using the particular Javascript library.

As shown at reference 120, the LLM device 315 may provide the LLM-generated code to the data processing system 310. In this way, the data processing system 310 may obtain LLM-generated code associated with providing a visualization of the data responsive to the data request for display to the user.

In some implementations, the data processing system 310 may cause the visualization of the data responsive to the data request to be provided for display to the user based on the LLM-generated code. For example, as shown at reference 122, the data processing system 310 may provide the LLM-generated code to the user device 305 and, as shown at reference 124 the user device 305 may execute the LLM-generated code such that the visualization is provided for display on the user device 305.

Additionally, or alternatively, to cause the visualization to be provided for display to the user, the data processing system 310 may in some implementations generate a static visualization (e.g., an image file). For example, the data processing system 310 may generate a static visualization based on the LLM-generated code, and provide information associated with the static visualization to the user device 305 (e.g., such that the user device 305 can provide the static visualization for display to the user).

In some implementations, the data processing system 310 may update the visualization based on user input. For example, the data processing system 310 may receive (e.g., via user device 305) information associated with one or more characteristics of the visualization that the user wishes to be updated or modified. Here, the data processing system 310 may, based on the information associated with the desired updates, obtain updated LLM-generated code from the LLM device 315 (e.g., in the manner described above), and may cause the updated visualization to be provided for display to the user (e.g., in the manner described above). In this way, the use of LLM-generated code may enable a user to specify and/or modify any characteristic of the visualization based on user input using natural language, meaning that the user need not understand intricacies of a user interface configuration to be provided with a desired visualization. Put another way, the data processing system 310 may in some implementations enable user customization of the visualization. In some implementations, such customization may go beyond conventional customization. For example, the data processing system 310 may enable customization to provide a color-blind-friendly visualization or providing an output that is accessible for a user with a disability.

As indicated above, FIGS. 1A and 1B are provided as an example. Other examples may differ from what is described with regard to FIGS. 1A and 1B. For example, while example 100 is an example in the context of a visualization of data, the techniques and apparatuses described herein can be applied in any application that uses consistent standards, patterns, technologies, or libraries. For instance, the techniques and apparatuses described herein may be utilized in an extract, transform, and load (ETL) application (e.g., in association with moving and/or deriving new data based on data) that relies on SQL, APIs, and software development kits (SDKs). Similarly, an output provided by execution of the LLM-generated code may be comprise one or more items or actions other a visualization. For example, the LLM-generated code can be executed to perform one or more calculations, compute one or more statistics, or compute one or more metrics (e.g., a credit score percentile, a profit metric, or the like). Further, data analysis could be performed such as identification of outliers or bad data. These other outputs provided by execution of the LLM-generated code could in some implementations be visualized (e.g., in charts or graphics) or simply provided for display as the values themselves.

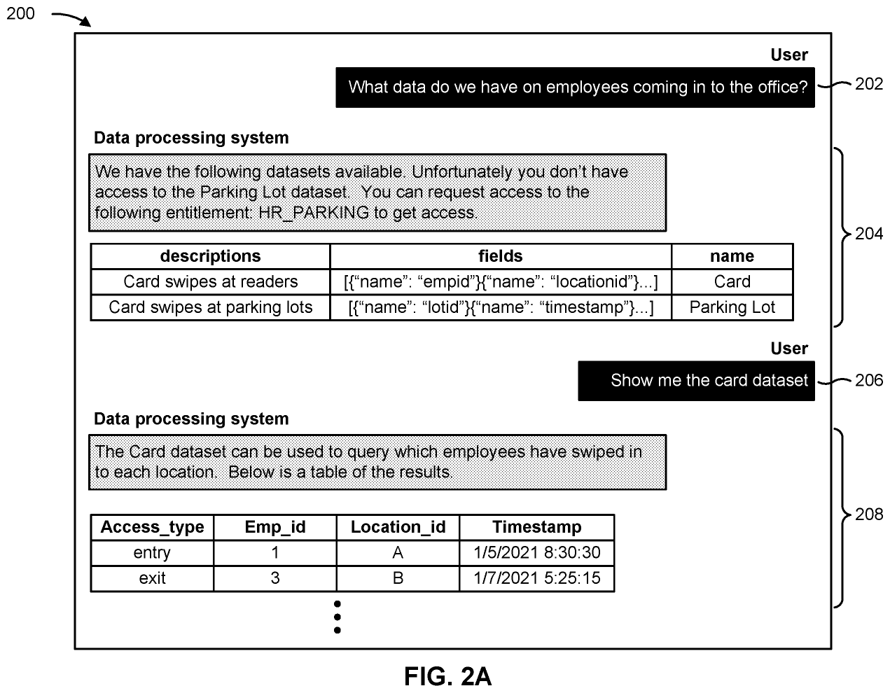

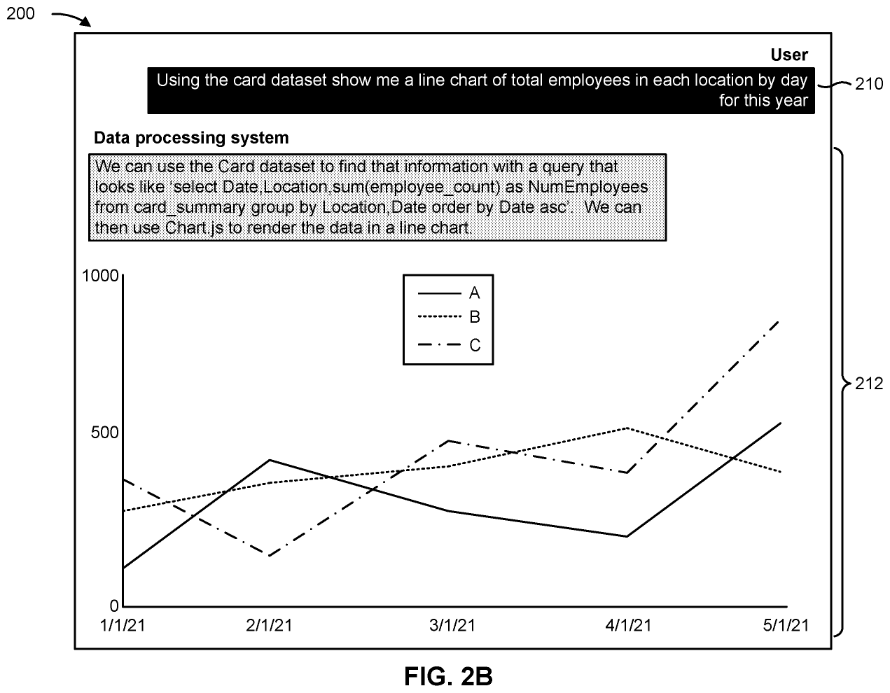

FIGS. 2A and 2B are diagrams of an illustrative example 200 associated with visualization of data responsive to a data request using an LLM. Example 200 is illustrated from the perspective of a user of a user device 305.

At reference 202, a user provides a first data request to the data processing system 310 via the user device 305. In this example, the first data request comprises a textual string requesting data on employees coming into an employer office (e.g., “What data do we have on employees coming in to the office?”)

In this example, as indicated at reference 204, the data processing system 310 obtains information that identifies a card dataset and a parking lot dataset that may include data relevant to the data request. In some implementations, the data processing system 310 may obtain the information that identifies the card dataset and the parking dataset from the LLM device 315 (e.g., based on the LLM device 315 identifying the card dataset and the parking dataset as including data relevant to the data request). As shown, the data processing system 310 provides a table including information associated with the card dataset and information associated with the parking lot dataset. Here, the information associated with a given dataset includes a description of the dataset, fields of data included in the dataset, and the name of the dataset. Further, in this example, the data processing system 310 determines that the user is authorized to access card dataset, but is not authorized to access the parking lot dataset, and notifies the user accordingly.

At reference 206, the user provides input indicating that the user wishes to view the card dataset (e.g., “Show me the card dataset”).

At reference 208, in response to the user input indicating that the user wishes to view the card dataset, the data processing system 310 provides the user with information that describes the data in the card dataset and a table comprising data in the card dataset. In some implementations, the data processing system 310 obtains the data from the card dataset using an LLM-generated query. For example, the data processing system 310 may request, from the LLM device 315, a query associated with retrieving the data in the card dataset. The LLM device 315 may generate the query based on the request and provide the LLM-generated query to the data processing system 310. The data processing system 310 may then execute the LLM-generated query to retrieve the data included in the card dataset (e.g., from a data source 320 that stores the card dataset).

As shown in FIG. 2B at reference 210, the user provides a second data request indicating that user wishes to view a visualization of the card dataset according to a set of characteristics desired by the user. In this example, the set of characteristics includes (1) line chart, (2) total employees by location, and (3) the current year.

At reference 212, the data processing system 310 provides a visualization according to the desired characteristics in response to the second data request. In some implementations, the data processing system 310 obtains the data associated with the visualization using an LLM-generated query. For example, the data processing system 310 may request, from the LLM device 315, a query associated with retrieving data in the card dataset in accordance with the desired characteristics. The LLM device 315 may generate the query based on the request and provide the LLM-generated query to the data processing system 310. The data processing system 310 may then execute the LLM-generated query to retrieve the data included in the card dataset that is relevant to the second data request. In this example, as indicated by reference 212, the LLM-generated query is generated so as to provide data according to the characteristics specified by the user (e.g., such that data is provided in the form of a number of employees by location and is ordered by ascending date in the current year).

As further shown, the data processing system 310 may cause the visualization to be provided for display to the user. In some implementations, the data processing system 310 causes the visualization to be provided for display using LLM-generated code. For example, the data processing system 310 may request, from the LLM device 315, code associated with providing a visualization of the data to be display to the user. The LLM device 315 may generate the code based on the code request and provide the LLM-generated code to the data processing system 310. The data processing system 310 may then provide the LLM-generated code to the user device 305, and the user device 305 may execute the LLM-generated code to cause the visualization to be displayed to the user. In example 200, the LLM-generated code provides a visualization according to the desired characteristics—in particular, a line chart showing total employees by location (e.g., location A, location B, or location C) by day for the current year.

As indicated above, FIGS. 2A and 2B are provided as an example. Other examples may differ from what is described with regard to FIGS. 2A and 2B.

FIG. 3 is a diagram of an example environment 300 in which systems and/or methods described herein may be implemented. As shown in FIG. 3, environment 300 may include a user device 305, a data processing system 310, an LLM device 315, one or more data sources 320, a metadata device 325, and a network 330. Devices of environment 300 may interconnect via wired connections, wireless connections, or a combination of wired and wireless connections.

The user device 305 may include one or more devices capable of receiving, generating, storing, processing, and/or providing information associated with visualization of data responsive to a data request using an LLM, as described elsewhere herein. The user device 305 may include a communication device and/or a computing device. For example, the user device 305 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The data processing system 310 may include one or more devices capable of receiving, generating, storing, processing, providing, and/or routing information associated with visualization of data responsive to a data request using an LLM, as described elsewhere herein. The data processing system 310 may include a communication device and/or a computing device. For example, the data processing system 310 may include a server, such as an application server, a client server, a web server, a database server, a host server, a proxy server, a virtual server (e.g., executing on computing hardware), or a server in a cloud computing system. In some implementations, the data processing system 310 may include computing hardware used in a cloud computing environment.

The LLM device 315 may include one or more devices capable of receiving, generating, storing, processing, providing, and/or routing information associated with visualization of data responsive to a data request using an LLM, as described elsewhere herein. The LLM device 315 may include a communication device and/or a computing device. For example, the LLM device 315 may include a server, such as an application server, a client server, a web server, a database server, a host server, a proxy server, a virtual server (e.g., executing on computing hardware), or a server in a cloud computing system. In some implementations, the LLM device 315 may include computing hardware used in a cloud computing environment.

A data source 320 may include one or more devices capable of receiving, generating, storing, processing, and/or providing information (e.g., data) associated with visualization of data responsive to a data request using an LLM, as described elsewhere herein. The data source 320 may include a communication device and/or a computing device. For example, the data source 320 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. In some implementations, the data source 320 may include one or more databases.

The metadata device 325 may include one or more devices capable of receiving, generating, storing, processing, providing, and/or routing information associated with visualization of data responsive to a data request using an LLM, as described elsewhere herein. The metadata device 325 may include a communication device and/or a computing device. For example, the metadata device 325 may include a server, such as an application server, a client server, a web server, a database server, a host server, a proxy server, a virtual server (e.g., executing on computing hardware), or a server in a cloud computing system. In some implementations, the metadata device 325 may include computing hardware used in a cloud computing environment.

The network 330 may include one or more wired and/or wireless networks. For example, the network 330 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 330 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with visualization of data responsive to a data request using an LLM. The device 400 may correspond to user device 305, data processing system 310, LLM device 315, data source 320, and/or metadata device 325. In some implementations, user device 305, data processing system 310, LLM device 315, data source 320, and/or metadata device 325 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

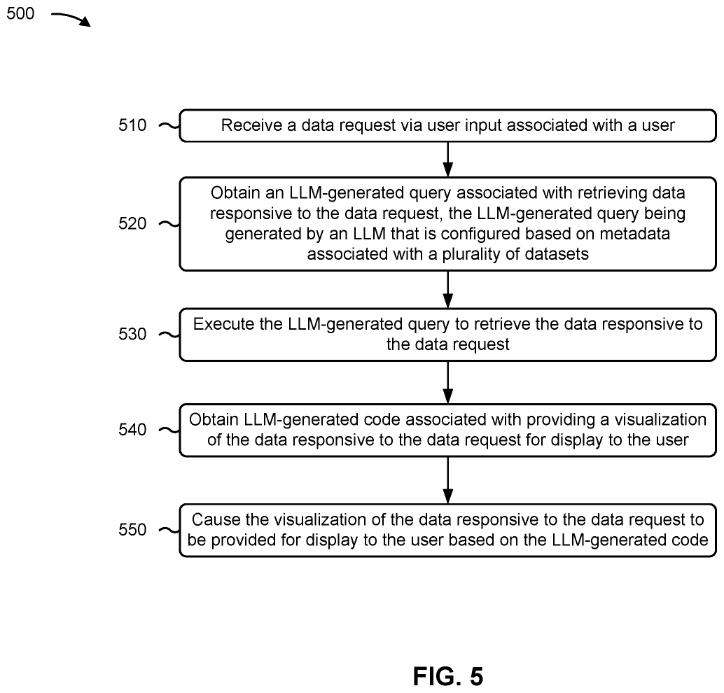

FIG. 5 is a flowchart of an example process 500 associated with visualization of data responsive to a data request using an LLM. In some implementations, one or more process blocks of FIG. 5 may be performed by the data processing system 310. In some implementations, one or more process blocks of FIG. 5 may be performed by another device or a group of devices separate from or including the data processing system 310, such as the user device 305, the LLM device 315, and/or the metadata device 325. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving the data request via user input associated with a user (block 510). For example, the data processing system 310 (e.g., using processor 420, memory 430, input component 440, and/or communication component 460) may receive the data request via user input associated with a user, as described above in connection with reference 102 of FIG. 1A. As an example, the data processing system 310 may receive a data request indicating that the user wishes to view a line chart displaying total employee card swipes across a group of locations by day for a current year.

As further shown in FIG. 5, process 500 may include obtaining an LLM-generated query associated with retrieving the data responsive to the data request, the LLM-generated query being generated by an LLM that is configured based on metadata associated with a plurality of datasets (block 520). For example, the data processing system 310 (e.g., using processor 420 and/or memory 430) may obtain an LLM-generated query associated with retrieving the data responsive to the data request, the LLM-generated query being generated by an LLM that is configured based on metadata associated with a plurality of datasets, as described above in connection with reference 110 of FIG. 1A. As an example, the data processing system 310 may obtain an LLM-generated query associated with retrieving data that indicates total employee card swipes across the group of locations by day for the current year from a card dataset stored by a data source 320.

As further shown in FIG. 5, process 500 may include executing the LLM-generated query to retrieve the data responsive to the data request (block 530). For example, the data processing system 310 (e.g., using processor 420 and/or memory 430) may execute the LLM-generated query to retrieve the data responsive to the data request, as described above in connection with reference 112 of FIG. 1A. As an example, the data processing system 310 may execute the LLM-generated query to retrieve the data that indicates total employee card swipes across the group of locations by day for the current year from the card dataset.

As further shown in FIG. 5, process 500 may include obtaining LLM-generated code associated with providing the visualization of the data responsive to the data request for display to the user (block 540). For example, the data processing system 310 (e.g., using processor 420 and/or memory 430) may obtain LLM-generated code associated with providing the visualization of the data responsive to the data request for display to the user, as described above in connection with reference 120 of FIG. 1B. As an example, the data processing system 310 may obtain LLM-generated code associated with providing the line chart including the data that indicates total employee card swipes across the group of locations by day for the current year.

As further shown in FIG. 5, process 500 may include causing the visualization of the data responsive to the data request to be provided for display to the user based on the LLM-generated code (block 550). For example, the data processing system 310 (e.g., using processor 420 and/or memory 430) may cause the visualization of the data responsive to the data request to be provided for display to the user based on the LLM-generated code, as described above in connection with references 122 and 124 of FIG. 1B. As an example, the data processing system 310 may provide the LLM-generated code associated with providing the line chart including the data that indicates total employee card swipes across the group of locations by day for the current year to the user device 305, and the user device 305 may execute the LLM-generated code in order to provide the line chart for display to the user.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A and 1B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of”′ a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for causing a visualization of data responsive to a data request to be provided for display based on large language model (LLM)-generated code, the system comprising:
one or more memories; and
one or more processors, communicatively coupled to the one or more memories, configured to:
receive the data request via user input associated with a user;
obtain an LLM-generated query associated with retrieving the data responsive to the data request, the LLM-generated query being generated by an LLM that is configured based on metadata associated with a plurality of datasets;
execute the LLM-generated query to retrieve the data responsive to the data request;
obtain LLM-generated code associated with providing the visualization of the data responsive to the data request for display to the user; and
cause the visualization of the data responsive to the data request to be provided for display to the user based on the LLM-generated code.

2. The system of claim 1, wherein the one or more processors are further configured to:
obtain information that identifies one or more datasets of the plurality of datasets, the one or more datasets being identified by the LLM and based on the data request; and
provide the information that identifies the one or more datasets for display to the user.

3. The system of claim 2, wherein the one or more processors are further configured to receive user input indicating at least one selected dataset of the one or more datasets, wherein the LLM-generated query is a query associated with the at least one selected dataset.

4. The system of claim 1, wherein the one or more processors are further configured to determine that the user is authorized to access a dataset of plurality of datasets that includes the data responsive to the data request.

5. The system of claim 1, wherein the one or more processors, to cause the visualization to be provided for display to the user, are configured to provide the LLM-generated code for execution by a user device associated with the user.

6. The system of claim 1, wherein the one or more processors, to cause the visualization to be provided for display to the user, are configured to:
generate a static visualization based on the LLM-generated code, and
provide information associated with the static visualization to a user device associated with the user.

7. The system of claim 1, wherein the one or more processors, to obtain the LLM-generated query, are configured to:
provide the data request as an input to the LLM that is configured based on the metadata associated with the plurality of datasets; and
receive the LLM-generated query as an output of the LLM.

8. A method for causing a visualization of data responsive to a data request to be provided for display, comprising:
receiving, by a system, the data request;
obtaining, by the system, a query associated with retrieving the data responsive to the data request, wherein the query is a first output of a large language model (LLM) that is trained based on metadata associated with a plurality of datasets;
retrieving, by the system and based on the query, the data responsive to the data request, the data being retrieved from at least one dataset of the plurality of datasets;
obtaining, by the system, code associated with providing the visualization of the data responsive to the data request for display, wherein the code is a second output of the LLM; and
causing, by the system and based on the code, the visualization of the data responsive to the data request to be provided for display.

9. The method of claim 8, further comprising:
obtaining information that identifies one or more datasets of the plurality of datasets, the one or more datasets being identified by the LLM based on the data request; and
providing the information that identifies the one or more datasets for display.

10. The method of claim 9, further comprising receiving input indicating the at least one dataset, wherein the at least one dataset is included in the one or more datasets and the query is associated with the at least one dataset.

11. The method of claim 8, further comprising performing an authorization associated with accessing the at least one dataset of the plurality of datasets.

12. The method of claim 8, wherein causing the visualization to be provided for display comprises providing the code for execution by a user device.

13. The method of claim 8, wherein causing the visualization to be provided for display comprises:
generating a static visualization based on the code, and
providing information associated with the static visualization to a user device.

14. The method of claim 8, wherein obtaining the query comprises:
providing the data request as an input to the LLM; and
receiving the first output of the LLM, wherein the first output comprises the query.

15. A non-transitory computer-readable medium storing a set of instructions, the set of instructions comprising:
one or more instructions that, when executed by one or more processors of a system, cause the system to:
receive a request associated with a plurality of datasets;
obtain a large language model (LLM)-generated query associated with retrieving data, from one or more datasets of the plurality of datasets, that is responsive to the request;
execute the LLM-generated query to retrieve the data;
obtain LLM-generated code associated with a visualization of the data; and
cause, based on the LLM-generated code, the visualization of the data to be provided for display.

16. The non-transitory computer-readable medium of claim 15, wherein the one or more instructions further cause the system to:
obtain information that identifies a set of datasets, the set of more datasets being identified by an LLM based on the data request; and
provide the information that identifies the set of datasets for display.

17. The non-transitory computer-readable medium of claim 16, wherein the one or more instructions further cause the system to receive input indicating the one or more datasets, wherein the one or more datasets are included in the set of datasets.

18. The non-transitory computer-readable medium of claim 15, wherein the one or more instructions further cause the system to determine that access to the one or more datasets is authorized.

19. The non-transitory computer-readable medium of claim 15, wherein the one or more instructions, to cause the visualization to be provided for display, cause the system to provide the LLM-generated code for execution by a user device.

20. The non-transitory computer-readable medium of claim 15, wherein the one or more instructions, to cause the visualization to be provided for display, cause the system to:
generate a static visualization based on the LLM-generated code, and
provide information associated with the static visualization to a user device.
